(19) United States
(12) Patent Application Publication
(10) Pub. No.: US 2018/0286551 A1
(43) Pub. Date: Oct. 4, 2018

(54) SUPPORT STRUCTURES FOR HTS MAGNETS

(71) Applicant: TOKAMAK ENERGY LTD, Oxfordshire (GB)

(72) Inventors: Elwyn BAYNHAM, Oxfordshire (GB); Paul NOONAN, Oxfordshire (GB)

(21) Appl. No.: 15/757,040

(22) PCT Filed: Sep. 2, 2016
(86) PCT No.: PCT/GB2016/052718

§ 371 Date: Mar. 2, 2018

(30) Foreign Application Priority Data
Sep. 4, 2015 (GB) 1515726.6

(51) Int. Cl. H01F 6/06; H01F 6/04; G21B 1/05

(52) U.S. Cl. CPC H01F 6/065; G21B 1/21; G21B 1/057; H01F 6/04

(57) ABSTRACT

Disclosed herein is a support structure for a field coil comprising high temperature superconductor, HTS. The support structure comprises an internal load transfer member configured to attach at one end to the field coil and at another end to an inner surface of a vacuum vessel containing the field coil and configured to support the field coil. At least part of the internal load transfer member is configured to remain at room temperature during operation of the HTS magnet and is not cooled by the cooling system used to cool the field coil.

### TECHNICAL FIELD OF THE INVENTION

The present invention relates to support structures for magnets, and in particular to support structures for magnets comprising high temperature superconductors (HTS), and in particular magnets used to provide poloidal and toroidal field to Tokamaks.

### BACKGROUND

A superconducting magnet is an electromagnet formed from coils of a superconducting material (“field coils”). As the magnet coils have zero resistance, superconducting magnets can carry high currents with zero loss (though there will be some losses from non-superconducting components), and can therefore reach much higher fields that conventional electromagnets.

Superconductivity only occurs in certain materials, and only at low temperatures. A superconducting material will behave as a superconductor in a region defined by the critical temperature of the superconductor (the highest temperature at which the material is a superconductor in zero magnetic field) and the critical field of the superconductor (the highest magnetic field in which the material is a superconductor at 0K). The temperature of the superconductor and the magnetic field present limit the current which can be carried by the superconductor without the superconductor becoming resistive.

Broadly speaking, there are two types of superconducting material. Low temperature superconductors (LTS) have critical temperatures below 30K-40K, and high temperature superconductors (HTS) have critical temperatures above 30K-40K. Many current HTS materials have critical temperatures above 77K, which allows the use of liquid nitrogen for cooling.

As the magnets require cooling to low temperatures, they are typically contained within a cryostat designed to minimise heating of the magnet. Such a cryostat typically comprises a vacuum chamber to minimise heating by convection or conduction, and may comprise one or more heat shields at temperatures intermediate between the temperature of the magnet and the external temperature to minimise heating by radiation.

All support structures of the magnet are cooled to as low a temperature as possible to reduce the heat load on the field coil, and thus the cooling required for the field coil itself. In particular, any component which attaches to the magnet is cooled to reduce heat transfer by conduction, and any component with line of sight to the field coil should be cooled to reduce heat transfer by radiation.

For certain magnet structures, such as toroidal field coils for a tokamak plasma chamber, the electromagnetic loads on the magnet can be very high. The self-field of a toroidal field coil gives rise to a force which acts in the plane of each toroidal field coil, and acts from the interior of each field coil (i.e. from the vacuum vessel in a plasma chamber) outward. While there is no net force on the field coil from the self-field, the effect of the EM forces is a strong internal tension of the field coil. In practice, it can be considered that the toroidal field coils are constantly under an outward pressure that tends to push them towards “bursting”.

In addition to the self-field, the interaction between the toroidal field coil current and the poloidal field (produced by the plasma current) in a tokamak produce a load normal to the plane of the field coil, which acts to twist the toroidal field magnet with opposing toroidally directed forces. This force is lower than that produced by the self-field, but it is often pulsed which may impose additional stresses on support structures.

Support structures to counteract the EM forces of toroidal field coils take the form of inter-coil structures and coil cases, which increase both the stiffness and strength of the magnet assembly. These structures are kept within the cooled volume of the cryostat containing the magnet, to avoid transferring heat to the magnet.

### SUMMARY

In accordance with one aspect of the present invention there is provided a support structure for a field coil comprising high temperature superconductor, HTS. The support structure comprises an internal load transfer member configured to attach at one end to the field coil and at another end to an inner surface of a vacuum vessel containing the field coil and configured to support the field coil against electromagnetic forces acting on the field coil. At least part of the internal load transfer member is configured to remain at room temperature during operation of the HTS magnet.

In practice, in operation the end of the internal load transfer member attached to the field coil may be at substantially the same temperature as the field coil (e.g. about 30 K), and the other end may be at room temperature, so there is likely to be a temperature gradient along the internal load transfer member. It may be that some of the internal load transfer member is cooled or that the internal load transfer member is not cooled.

The support structure may comprise an external support member configured to support the inner support member. The external support member may be integrated with the vacuum vessel or attached to an outer surface of the vacuum vessel. The external support structure is not cooled.

The internal load transfer member may be configured to attach to the upper inner surface of the vacuum vessel, and to an upper portion of the field coil. The internal load transfer member may comprise a laminated material (e.g. a glass fibre epoxy material), with a plane of the laminated material being perpendicular to a load axis of the internal load transfer member. Alternative materials include uni-directional fibres of glass, carbon, Kevlar, Zylon arranged in the direction of the load and embedded in epoxy with bands wound round to contain bursting stresses. Metal tubes may also be used with suitable anti-buckling bands installed.

The field coil may be a toroidal field coil (for example for confining a plasma in a tokamak), the internal load transfer member being configured to attach to a return limb of the toroidal field coil.

In accordance with one embodiment there is provided a cryostat for an HTS field coil, comprising a support structure as described above and a vacuum vessel enclosing the inner support member and the field coil. The cryostat may further comprise a heat shield located between the vacuum vessel and the field coil and a cooling system for cooling the heat shield (optionally using liquid nitrogen) to an intermediate temperature between a temperature of the field coil and a temperature of the vacuum vessel. The cooling system may also be used to cool an inner part of the internal load transfer member. The internal load transfer member may pass through the heat shield.

In accordance with one embodiment there is provided a superconducting magnet comprising a cryostat as described above, an HTS field coil, and a cooling system configured to cool the field coil to a temperature below the critical temperature of the HTS, where an external support member is not directly cooled by the cooling system.

In accordance with one embodiment there is provided a nuclear fusion reactor comprising a cryostat as described above, an HTS toroidal field coil to which the internal load transfer member is attached, two or more HTS poloidal field coils, a spherical tokamak plasma chamber, and a cooling system configured to cool the toroidal and poloidal field coils to a temperature below the critical temperature of the HTS. The internal load transfer member need not be directly cooled by the cooling system. A second internal load transfer member may be attached to the poloidal field coil. The external supports of the cryostat are not cooled by the cooling system.

In accordance with one embodiment there is provided a superconducting magnet. The superconducting magnet comprises a field coil, a cooling system, a vacuum vessel, and an internal load transfer member. The field coil comprises HTS. The cooling system is for cooling the field coil to a temperature below a critical temperature of the HTS. The vacuum vessel contains the field coil. The internal load transfer member configured to attach at one end to the field coil and at another end to an inner surface of a vacuum vessel containing the field coil and configured to support the field coil against electromagnetic forces acting on the field coil. At least part of the internal load transfer member is configured to remain at room temperature during operation of the field coil.

### BRIEF DESCRIPTION OF THE DRAWINGS

Some preferred embodiments of the invention will now be described by way of example only and with reference to the accompanying drawings, in which:

FIG. 1 is a schematic diagram of an exemplary HTS field coil, cryostat, and support structure; and

FIG. 2 is a schematic diagram of a supported toroidal HTS field coil.

### DETAILED DESCRIPTION

Due to the high forces applied to a toroidal field coil during operation, support structures inside the cool volume may be inadequate for high-field and/or low radius toroidal field coils. Due to the perceived need in the prior art to keep the EM support structures cool, it is effectively not possible to transfer forces from the toroidal field coils to external supports, but instead the strength of the supporting structures themselves is relied on to support the field coils. This is a particular issue because the loads on the toroidal field coils are not axisymmetric (rotationally symmetrical about the central column), which makes it difficult to design support structures which can be contained within the cool volume.

In contrast to the conventional approach to building superconducting magnets, it is proposed that the supports of an HTS toroidal field coil may be left uncooled without making a significant difference to the heat load of the magnet. This can be done as the cost of removing excess heat at HTS operating temperatures (typically around 30K) is much less than the cost of removing heat at LTS operating temperatures (typically around 4K). The extra heat will add to the power required to keep the magnet cool, but allows for greatly simplified design of the support structures, and reduces the size of the cryostat, vacuum vessel and heat shields required (as they need only enclose the magnet itself, and not the supports).

The use of room temperature supports is particularly attractive for applications with an already high heat load such as nuclear fusion reactors—the heat load from such a reactor is much greater than the excess heat load due to the room temperature supports, and so the cooling system can easily cope with the extra heat.

In addition, most conventional superconducting magnets are axisymmetric. Any loads caused by electromagnetic forces can be contained within the cold volume.

By contrast, the toroidal field coils used to contain plasma in a tokamak fusion reactor are not axisymmetric and have very challenging stress distributions. In particular, during normal operation of the tokamak the self-field of the toroidal field coil leads to a force distribution acting outwards in the plane of the coil.

The support structure for the field coil comprises an internal load transfer member which connects to the magnet and the inner surface of the vacuum vessel of the cryostat. The support structure may also comprise an external support member which connects to the outer surface of the vacuum vessel at a location corresponding to the point where the internal load transfer member is attached, and bears the load exerted by the internal load transfer member. The external support member may be integrated with the vacuum chamber, e.g. as extra re-enforcement to the vacuum vessel structure.

The loads supported by the internal load transfer member may include gravitational loads (i.e. due to the weight of the magnet structure) and/or electromagnetic loads (i.e. due to the electromagnetic forces acting on the magnet structure). It is expected that during operation of a toroidal field magnet, the electromagnetic loads will be significantly higher than the gravitational loads.

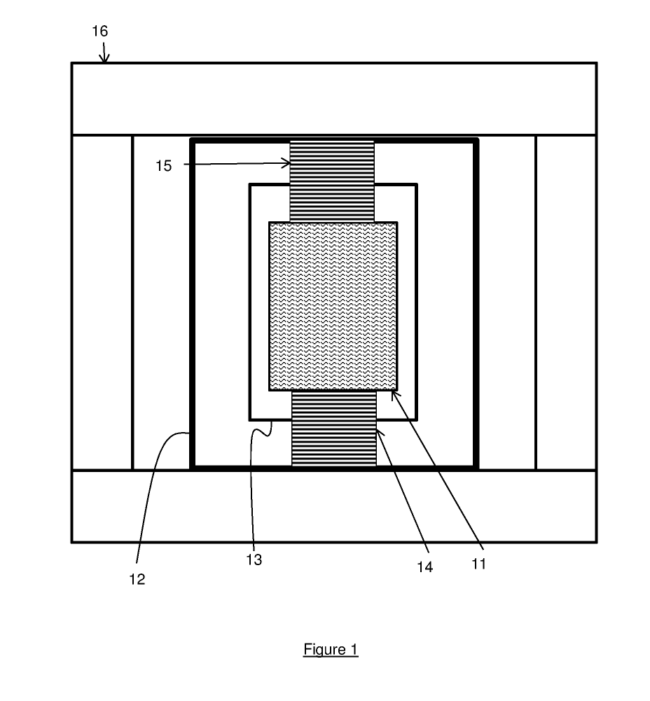

FIG. 1 shows an exemplary HTS field coil, cryostat, and support structure according to an embodiment. The HTS field coil 11 is cooled to 30K by a cooling system (not shown), and is inside a vacuum vessel 12 which is at room temperature (about 300K). Between the HTS field coil and the vacuum vessel is a thermal shield 13 which is cooled, also by a cooling system (not shown). This cooling may be to 77K, e.g. by liquid nitrogen (or by hydrogen or helium).

The temperatures given are by way of example only. The HTS field coil may be cooled to any temperature below the critical temperature of the magnet (depending on the application), and the thermal shield may be at any temperature between the temperature of the vacuum vessel and the temperature of the HTS field coil. Multiple thermal shields may be provided at decreasing temperatures between the vacuum vessel and the HTS field coil. It will also be appreciated that “room temperature” may not mean precisely 300K, but is intended to cover any temperature above about 270K.

The HTS field coil is supported by internal load transfer members 14 and 15. The lower internal load transfer member 14 connects to the base of the magnet and to the base of the vacuum vessel. The upper internal load transfer member 15 connects to the top of the magnet and to the upper inner surface of the vacuum vessel. Both internal load transfer members 14 and 15 pass through the thermal shield, and there will be a temperature gradient in the supports from room temperature where they are joined to vacuum vessel 12 to the HTS operating temperature where they are joined to HTS field coil 11. The internal load transfer members transfer loads resulting from the EM forces on the field coil to the vacuum vessel. The loads from the EM forces will generally be in the plane of the field coil and outward from the field coil (with some toroidal loads from the interaction between the current in the toroidal field coil and the poloidal field).

An external support 16 is attached to the outer upper surface of the vacuum vessel 12, to bear the load exerted by the upper internal load transfer member 15. The external support 16 and upper internal load transfer member 15 may be attached only to the vacuum vessel 12, or they may be attached to each other by structures which pass through the vacuum vessel 12, provided such structures maintain the seal of the vacuum vessel 12. For example, one or more bolts may attach the internal load transfer member 15 to the external support 16 through holes in the vacuum vessel 12, and a seal may be provided between the internal load transfer member 15 and the vacuum vessel 12 and/or between the external support 16 and the vacuum vessel 12 to avoid leaks through the bolt holes. As a further example, the internal load transfer members and external support members may together comprise a strut which passes through the vacuum vessel (i.e. with the sections inside acting as internal load transfer members, and the parts outside acting as external support members). The external support supports the loads exerted by the inner load transfer members onto the vacuum vessel.

The external support may be provided as a frame or other structure 16 outside the vacuum vessel as shown in FIG. 1, or it may be integrated with the vacuum vessel, e.g. by using a re-enforced vacuum vessel configured to support the loads transferred by the internal load transfer members. The external support may comprise a combination of re-enforcement to the vacuum vessel and support structures outside the vacuum vessel.

It will be appreciated that load transferring members passing through a heat shield are generally connected to it thermally. This can be done by flexible links so that the mechanical load is still transferred to room temperature, but some of the conducted heat is removed at higher temperatures where it is more efficient. For example an intermediate thermal link may thermally (but not mechanically) connect the internal load transfer member to a liquid nitrogen temperature shield. This imposes a high heat load, but this does not matter because cooling at 77K is inexpensive. This allows for sections of the internal load transfer member close to the HTS coil to be at a reduced temperature, reducing the heat load at low temperature where cooling is more expensive. The intermediate thermal link may comprise a metal plate between the two thermally insulating blocks that make up the internal load transfer member.

The internal load transfer members 14 and 15 each act to support the field coil 11. The direction of the force on each internal load transfer member defines an axis of load for that member.

The internal load transfer members 14 and 15 may be of any suitable load-bearing structure, and may be of any sufficiently strong non-magnetic material. The structure of the internal load transfer members and their attachment to the field coil will depend on the shape of the field coil, but this is well within the scope of normal design work for the skilled person, especially as cooling for the supports does not need to be taken into account (unlike with conventional cooled supports).

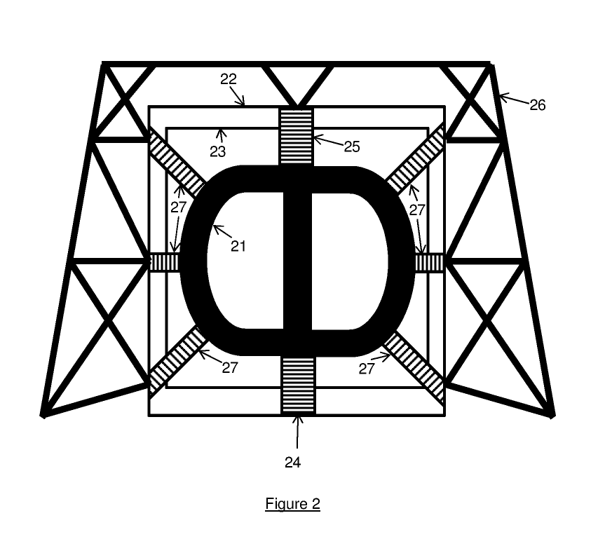

For example, as shown in FIG. 2, where the field coil 21 is a toroidal field coil with a central column and a plurality of return limbs, the internal load transfer members 24 and 25 may be columns fixed to the top and bottom of the central column. The internal load transfer members 24 and 25 may be formed of a laminated material with the laminate sheets being perpendicular to the axis of load. One suitable laminated material is formed from G10 or G11 glass fibre epoxy laminate sheets. Additional internal load transfer members 27 may be attached to the return limbs. These additional load transfer members 27 are particularly beneficial for supporting the field coil against electromagnetic forces. The internal load transfer members pass through the thermal shield 23 to the vacuum vessel 22. An external support frame 26 may also be provided to support the load from the internal load transfer members 27, 25, with the ground acting as external support for the internal load transfer member 24. Again, this external frame 26 is beneficial to provide support against the very considerable electromagnetic forces experienced by a toroidal field coil. It will be appreciated that a similar arrangement may be provided for a poloidal field coil (not shown in FIG. 2).

As mentioned above, such supports may be used for a fusion reactor such as a spherical tokamak reactor. A spherical tokamak comprises a toroidal plasma chamber, a toroidal field coil as described above, and at least two poloidal field coils which are circular field coils in a plane perpendicular to the central column. With suitable additional support for the plasma chamber and poloidal field coils, the support structure shown in FIG. 2 may be used for such a reactor. For example, the poloidal field coil and plasma chamber may be provided with additional internal load transfer members which connect them to the vacuum chamber, they may be mechanically connected to the toroidal field coil and supported by the same support members which support the toroidal field coil, or some combination of the two approaches may be used. There is relatively less advantage to the use of the support structures on the poloidal field coil, as the forces on the poloidal field coil are generally lower than those on the toroidal field coil, and generally axisymmetric.

1. A support structure for a field coil comprising high temperature superconductor, HTS, the support structure comprising:
an internal load transfer member configured to attach at one end to the field coil and at another end to an inner surface of a vacuum vessel containing the field coil and configured to support the field coil against electromagnetic forces acting on the field coil;
wherein at least part of the internal load transfer member is configured to remain at room temperature during operation of the field coil.

2. A support structure according to claim 1, and comprising an external support member configured to support the inner support member, wherein the external support member is integrated with the vacuum vessel or attached to an outer surface of the vacuum vessel.

3. A support structure according to claim 1, wherein the internal load transfer member is configured to attach to the upper inner surface of the vacuum vessel, and to an upper portion of the field coil.

4. A support structure according to claim 1, wherein the internal load transfer member comprises a laminated material, with a plane of the laminated material being perpendicular to a load axis of the internal load transfer member.

5. A support structure according to claim 4, wherein the laminated material is a glass fibre epoxy material.

6. A support structure according to claim 1, wherein the field coil is a toroidal field coil for confining plasma in a Tokamak and the internal load transfer member is configured to attach to an upper portion of a central column of the toroidal field coil.

7. A support structure according to claim 1, wherein the field coil is a toroidal field coil for confining plasma in a Tokamak and the internal load transfer member is configured to attach to a return limb of the toroidal field coil.

8. A support structure according to claim 1, wherein the field coil is a poloidal field coil for confining plasma in a Tokamak.

9. A cryostat for a field coil comprising high temperature superconductor, HTS, the cryostat comprising:
a support structure according to claim 1;
a vacuum vessel enclosing the inner support member and the field coil.

10. A cryostat according to claim 9, further comprising a heat shield located between the vacuum vessel and the field coil, the heat shield being configured for cooling to an intermediate temperature between a temperature of the field coil and a temperature of the vacuum vessel, wherein the internal load transfer member passes through the heat shield.

11. A cryostat according to claim 10, configured to cool the heat shield using liquid nitrogen.

12. A superconducting magnet comprising:
a cryostat according to claims 9;
a field coil comprising high temperature superconductor, HTS; and
a cooling system configured to cool the field coil to a temperature below the critical temperature of the HTS.

13. A superconducting magnet according to claim 12, wherein the internal load transfer member is not directly cooled by the cooling system.

14. A superconducting magnet according to claim 12, further comprising an external support frame outside the cryostat, and one or more external supports for transferring load from the internal load transfer member to the external support frame.

15. A nuclear fusion reactor comprising:
a cryostat according to claim 9;
a toroidal field coil comprising high temperature superconductor, HTS, to which the internal load transfer member is attached;
two or more poloidal field coils comprising HTS;
a spherical tokamak plasma chamber; and
a cooling system configured to cool the toroidal and poloidal field coils to a temperature below the critical temperature of the HTS.

16. A nuclear fusion reactor according to claim 15, and comprising a second internal load transfer member attached to the poloidal field coil.

17. A superconducting magnet, comprising:
a field coil comprising high temperature superconductor, HTS;
a cooling system for cooling the field coil to a temperature below a critical temperature of the HTS;
a vacuum vessel containing the field coil;
an internal load transfer member configured to attach at one end to the field coil and at another end to an inner surface of a vacuum vessel containing the field coil and configured to support the field coil against electromagnetic forces acting on the field coil;
wherein at least part of the internal load transfer member is configured to remain at room temperature during operation of the field coil.

18. A superconducting magnet according to claim 17, wherein the field coil is a toroidal or poloidal field coil for confining a plasma in a Tokamak.
